(19) United States
(12) Patent Application Publication
(10) Pub. No.: US 2026/0158989 A1
(43) Pub. Date: Jun. 11, 2026

(54) METHOD FOR OPTIMIZING ILLUMINATION OF A JUNCTION REGION BETWEEN A PLURALITY OF VEHICLES EMITTING A LIGHT BEAM

(71) Applicant: VALEO VISION, Bobigny (FR)

(72) Inventor: Rabih TALEB, Bobigny (FR)

(73) Assignee: VALEO VISION, Bobigny (FR)

(21) Appl. No.: 18/706,586

(22) PCT Filed: Oct. 26, 2022
(86) PCT No.: PCT/EP2022/080009

§ 371 Date: May 1, 2024

(30) Foreign Application Priority Data
Nov. 5, 2021 (FR) 2111749

(51) Int. Cl. B60Q 1/14; B60Q 1/00

(52) U.S. Cl. CPC B60Q 1/143; B60Q 1/0041; B60Q 2300/3321; B60Q 2300/47; B60Q 2900/30

(57) ABSTRACT

One aspect of the invention relates to a method for optimizing illumination in a junction region (202) between a plurality of vehicles (200-1, 200-2) emitting a light beam (201-1, 201-2), comprising ·Estimating a time interval in which each vehicle (200-1,A1 200-2) will be in the junction region (202); ·Estimating the illumination in the junction region (202) at any given time in the estimated time interval; ·If there is a region of overlap (2021) in which the estimated illumination corresponds to superposition of a plurality of light beams (201-1, 201-2): *Determining, via communication between the plurality of vehicles (200-1, 200-2) and on the basis of a set of parameters that are each relative to the consumption of one vehicle (200-1, 200-2), at least one action to be taken by a vehicle (200-1, 200-2) on its light beam (201-1, 201-2); *Taking each determined action in the junction region (202).

### TECHNICAL FIELD

The technical field of the invention is that of the illumination provided by vehicles, and in particular that of optimizing illumination provided by vehicles in a crossing zone between vehicles.

The present invention relates to a method for optimizing illumination of a crossing zone between a plurality of vehicles each emitting a light beam.

### BACKGROUND OF THE INVENTION

When the lights of a motor vehicle are turned on, a lighting module emits a light beam that illuminates part of the road located in front of the vehicle.

In the situation illustrated in FIG. 1 in which two vehicles 200-1, 200-2 with their lights turned on cross one another in a crossing zone 202, there is a zone of overlap 2021 between the two emitted light beams 201-1, 201-2 in which the brightness is greater than the brightness in that part of the crossing zone 202 illuminated by a single light beam. This zone of overlap 2021 therefore creates a zone of excess brightness in the crossing zone 202 that is liable to inconvenience drivers.

In order to overcome this drawback, one conventional method consists, for a vehicle, in detecting zones of overlap in advance and in imposing turn-off of the light beam in the detected zones of overlap.

However, such a method applied to both vehicles has the consequence that the zones of overlap are no longer illuminated at all and therefore exhibit a brightness lower than the regulatory minimum brightness needed to ensure driver safety.

There is therefore a need for a method that makes it possible to illuminate each zone of overlap with a brightness greater than the regulatory minimum brightness, without creating a zone of excess brightness.

### SUMMARY OF THE INVENTION

The invention offers a solution to the problems mentioned above by making it possible to illuminate each zone of overlap of a crossing zone in such a way as to obtain homogeneous illumination, that is to say illumination without any significant discontinuity, in the illuminated part of the crossing zone.

One aspect of the invention relates to a method for optimizing illumination in a crossing zone between a plurality of vehicles each comprising a lighting module emitting an associated light beam, the method comprising the following steps:
at least one vehicle estimating a location of the crossing zone and a time interval in which each vehicle is located in the crossing zone, based on a set of information comprising at least a location, a speed and a trajectory of each vehicle
at least one vehicle estimating the illumination in the crossing zone at the estimated location and at each instant of the estimated time interval, based, for each vehicle, on at least one characteristic of the associated light beam
if, for at least one instant of the estimated time interval, there is at least one zone of overlap in the crossing zone in which the estimated illumination corresponds to the superposition of a plurality of associated light beams:
at least one vehicle obtaining a set of parameters comprising at least one parameter per vehicle, each parameter depending on at least one datum sent beforehand to the vehicle by the vehicle associated with the parameter and relating to the consumption or the state of the lighting module of the vehicle associated with the parameter
determining, by communication between the plurality of vehicles and based on the obtained set of parameters, at least one action to be carried out by a vehicle on the associated light beam so that the illumination in the zone of overlap is distributed among the plurality of vehicles in such a way as to exhibit a predefined brightness
the corresponding vehicle carrying out each determined action when the plurality of vehicles are located in the crossing zone.

By virtue of the invention, the location of the crossing zone and the time interval during which the crossing between a plurality of vehicles will take place are estimated in order to reconstruct the illumination that will exist in the crossing zone at the estimated location at each instant of the estimated time interval.

It is then possible to detect, in advance, each zone of overlap in which the estimated illumination corresponds to the superposition between a plurality of light beams emitted by the plurality of vehicles.

The vehicles of the plurality of vehicles then have a time period before they actually cross in the crossing zone to make a common decision on at least one action relating to the light beam emitted by a vehicle, to be carried out in the zone of overlap to ensure a predefined brightness level therein.

The vehicles of the plurality of vehicles make a decision by communicating with one another, on the basis of a set of parameters comprising, for each vehicle, a parameter representative of the consumption of the vehicle and/or a parameter representative of the state of the lighting module of the vehicle and, once a decision has been made, each action decided upon is carried out when the plurality of vehicles cross one another in the crossing zone.

The invention therefore makes it possible to ensure, in the zone of overlap, a brightness greater than the regulatory minimum brightness but less than the brightness that would exist if no action were to be carried out, and therefore at the same time to optimize the illumination and to save energy and/or to reduce CO2 emissions.

Besides the features that have just been outlined in the previous paragraph, the method according to the invention may have one or more additional features from among the following, which are considered individually or in any technically feasible combination.

According to one variant embodiment, the method according to the invention furthermore comprises a step of at least one vehicle obtaining the set of information, comprising, for at least one item of information of the set of information relating to another vehicle of the plurality of vehicles, a sub-step of the vehicle receiving the information sent beforehand by the other vehicle, or a sub-step of determining the information using a sensor of the vehicle, or a sub-step of estimating the information based on at least one item of information relating to traffic and/or signaling.

According to one variant embodiment that is compatible with the previous variant embodiment, the method according to the invention furthermore comprises a step of at least one vehicle receiving at least one item of information relating to public lighting in the crossing zone at the estimated location and at each instant of the estimated time interval, the step of estimating the illumination in the crossing zone also being carried out based on each received item of information relating to public lighting.

The reconstruction of the illumination in the crossing zone thus takes into account public lighting in the crossing zone.

According to one variant embodiment that is compatible with the previous variant embodiments, the step of at least one vehicle estimating the illumination in the crossing zone comprises, for each characteristic of the light beam associated with another vehicle of the plurality of vehicles, a sub-step of the vehicle receiving the characteristic sent beforehand by the other vehicle.

According to one variant embodiment that is compatible with the previous variant embodiments, each characteristic is chosen from the following group of characteristics: type, shape, brightness, brightness with respect to a regulatory minimum brightness.

According to one variant embodiment that is compatible with the previous variant embodiments, each datum is chosen from the following group of data: range, remaining distance to be traveled, ratio between range and remaining distance to be traveled, fuel consumption, ratio between fuel consumption and remaining distance to be traveled, model, consumption of the lighting module, ratio between consumption of the lighting module and remaining distance to be traveled, brightness of the emitted light beam, brightness of the emitted light beam with respect to a regulatory minimum brightness, temperature of the lighting module.

According to one variant embodiment that is compatible with the previous variant embodiments, each parameter is chosen from the following group of parameters:
range, ratio between range and remaining distance to be traveled, fuel consumption, ratio between fuel consumption and remaining distance to be traveled, model, consumption of the lighting module, ratio between consumption of the lighting module and remaining distance to be traveled, temperature of the lighting module.

The decision-making regarding the action to be carried out thus takes into account the electricity or the fuel used by each vehicle to illuminate the zone of overlap.

According to one variant embodiment that is compatible with the previous variant embodiments, each action to be carried out is that of turning off or reducing the brightness of the associated light beam by a predetermined value.

According to one variant embodiment that is compatible with the previous variant embodiments, each parameter of the set of parameters has a type, and the step of determining each action to be carried out comprises the following sub-steps:
If each vehicle is associated with one and the same parameter type of the set of parameters:
Carrying out a comparison between the set of parameters in order to determine at least one optimum parameter
For as long as the plurality of vehicles are not located in the crossing zone and each action to be carried out has not been determined, the plurality of vehicles communicating with one another in order to decide on each action to be carried out in such a way as to maximize the amount of illumination in the zone of overlap provided by each vehicle associated with an optimum parameter of the set of parameters
Otherwise, the determined action is a first default action to be carried out by each vehicle on the associated light beam
Otherwise, the determined action is a second default action to be carried out by each vehicle on the associated light beam.

Vehicles associated with an optimum parameter, for example having the most electricity or fuel, thus make a greater effort to illuminate the zone of overlap than other vehicles.

According to one variant embodiment that is compatible with the previous variant embodiments, the method according to the invention furthermore comprises a step of each vehicle carrying out a third default action on the associated light beam when the plurality of vehicles are located in the crossing zone, if communication is interrupted between the plurality of vehicles before each action to be carried out has been determined.

An action is thus taken even if communication between the plurality of vehicles is interrupted.

A second aspect of the invention relates to a vehicle for implementing the method according to the invention, comprising:
a lighting module configured to emit a light beam;-a computer configured to:
estimate a location of the crossing zone and a time interval in which each vehicle is located in the crossing zone, based on a set of information comprising at least a location, a speed and a trajectory of each vehicle
estimate the illumination in the crossing zone at the estimated location and at each instant of the estimated time interval, based, for each vehicle, on at least one characteristic of the associated light beam
detect each zone of overlap in the crossing zone in which the estimated illumination corresponds to the superposition of a plurality of light beams;
if a zone of overlap is detected:
obtain a set of parameters comprising at least one parameter per vehicle, each parameter depending on at least one datum sent beforehand by the vehicle associated with the parameter
determine, by communicating with the other vehicles of the plurality of vehicles and based on the obtained set of parameters, at least one action to be carried out by a vehicle on the associated light beam so that the illumination in the zone of overlap is distributed among the plurality of vehicles in such a way as to exhibit a predefined brightness;
if a determined action is to be carried out, carry out the determined action on the light beam emitted by the lighting module when the plurality of vehicles are located in the crossing zone.

A third aspect of the invention relates to a computer program product comprising instructions that, when the program is executed on a computer, cause said computer to implement the steps of the method according to the invention.

A fourth aspect of the invention relates to a computer-readable recording medium comprising instructions that, when they are executed by a computer, cause said computer to implement the steps of the method according to the invention.

The invention and its various applications will be better understood upon reading the following description and upon studying the accompanying figures

### BRIEF DESCRIPTION OF DRAWINGS

The figures are presented by way of non-limiting indication of the invention.

FIG. 1 shows a schematic depiction of a crossing zone between two vehicles without implementing a method according to the invention.

FIG. 2 shows a schematic depiction of the implementation of the method according to the invention for two vehicles before they cross in a crossing zone.

FIG. 3 shows a schematic depiction of the crossing zone between the two vehicles of FIG. 2 after the method according to the invention has been implemented.

FIG. 4 is a block diagram illustrating the sequence of steps of the method according to the invention.

### DETAILED DESCRIPTION OF THE INVENTION

Unless stated otherwise, the same element appearing in different figures is provided with a single reference.

FIG. 1 has already been described with reference to the prior art.

The invention relates to a method for optimizing illumination in a crossing zone between a plurality of vehicles, that is to say between at least two vehicles.

Each vehicle of the plurality of vehicles is preferably a motor vehicle, such as a car, a motorcycle, a truck or even a bus.

Each vehicle of the plurality of vehicles may be a combustion, electric or hybrid vehicle.

Each vehicle of the plurality of vehicles may be an autonomous vehicle.

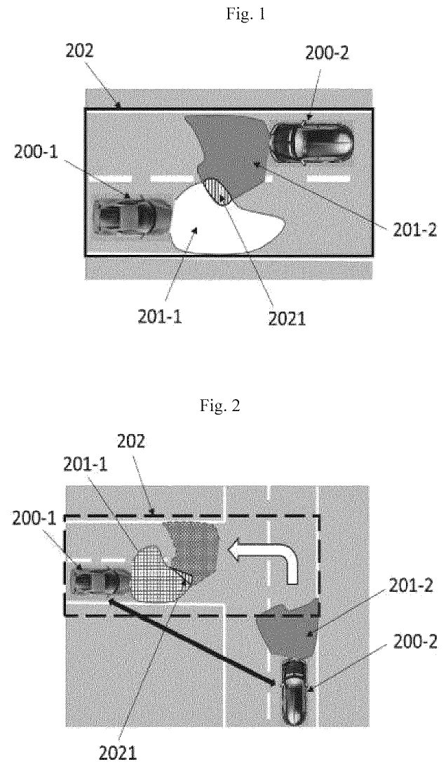

FIG. 2 shows a schematic depiction of the implementation of the method 100 according to the invention for two vehicles before they cross in a crossing zone 202.

In FIG. 2, the plurality of vehicles comprises a first, gray vehicle 200-1 and a second, black vehicle 200-2.

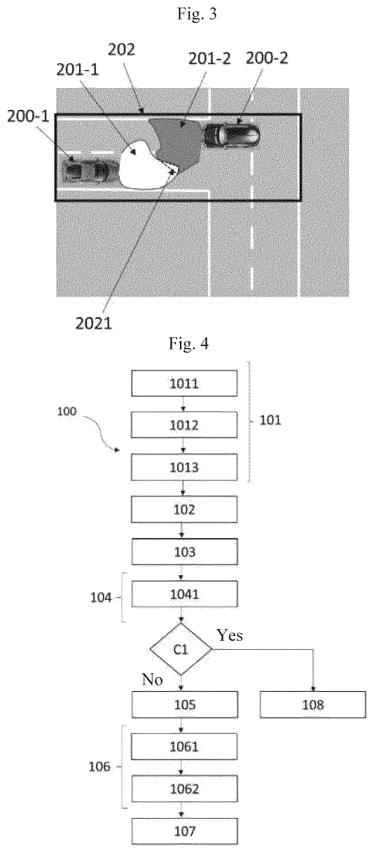

FIG. 3 shows a schematic depiction of the crossing zone 202 between the two vehicles of FIG. 2 after the method 100 according to the invention has been implemented.

FIG. 2 therefore corresponds to a first instant earlier than a second instant corresponding to FIG. 3.

Between the first instant and the second instant, the first vehicle 200-1 has not moved and the second vehicle 200-2 has made a left turn, as represented by a curved white arrow in FIG. 2.

Each vehicle 200-1, 200-2 of the plurality of vehicles comprises a lighting module configured to emit a light beam 201-1, 201-2 toward the front of the vehicle 200-1, 200-2.

In FIGS. 2 and 3, the first vehicle 200-1 emits a first light beam 201-1 and the second vehicle 200-2 emits a second light beam 201-2. Each light beam 201-1, 201-2 has at least one characteristic.

Each characteristic is chosen for example from the following group of characteristics:
type of the light beam 201-1, 201-2, shape of the light beam 201-1 201-2, brightness of the light beam 201-1, 201-2 or brightness of the light beam 201-1, 201-2 with respect to a regulatory minimum brightness.

If each vehicle 200-1, 200-2 is a motor vehicle, the possible types of light beams are for example low beams and high beams.

In FIGS. 2 and 3, the first light beam 201-1 and the second light beam 201-2 are low beams, but have a different shape.

Each vehicle 200-1, 200-2 of the plurality of vehicles has a predetermined trajectory, that is to say a known route.

The predetermined trajectory has for example been computed based on an address provided by the user of the vehicle 200-1, 200-2, by way of a navigation system integrated into or connected to the vehicle 200-1, 200-2, such as a GPS (Global Positioning System) navigation system integrated into a dedicated device or into a cell phone.

The vehicles 200-1, 200-2 of the plurality of vehicles are configured to communicate with one another, that is to say each vehicle 200-1, 200-2 is capable of communicating with the other vehicles 200-1, 200-2 of the plurality of vehicles and therefore of sending and receiving data to or from the other vehicles 200-1, 200-2 of the plurality of vehicles.

In FIG. 2, the communication between the first vehicle 200-1 and the second vehicle 200-2 is represented by a double-headed black arrow between the first vehicle 200-1 and the second vehicle 200-2.

The vehicles 200-1, 200-2 of the plurality of vehicles use for example a common data communication protocol.

The communication protocol that is used is Wi-Fi, 3G, 4G or even 5G.

The data communication protocol is preferably a secure data communication protocol.

FIG. 4 is a block diagram illustrating the sequence of steps of the method 100 according to the invention.

A first step 101 of the method 100 according to the invention consists, for at least one vehicle 200-1, 200-2 of the plurality of vehicles, in obtaining a set of information.

The first step 101 is for example carried out by each vehicle 200-1, 200-2 of the plurality of vehicles.

The set of information comprises at least a location, a speed and a trajectory of each vehicle 200-1, 200-2 of the plurality of vehicles.

Each item of information of the set of information is for example associated with a given instant, the set of information possibly comprising multiple items of information of the same type associated with different instants.

The set of information may for example comprise the location, the speed and the trajectory of a vehicle 200-1, 200-2 of the plurality of vehicles at a first instant and the location, the speed and the trajectory of the same vehicle 200-1, 200-2 at a second instant later than the first instant.

The first step 101 may comprise a first sub-step 1011 consisting, for at least one vehicle 200-1, 200-2 carrying out the first step 101, in receiving at least one item of information contained in the set of information relating to another vehicle 200-1, 200-2 of the plurality of vehicles, the information having been sent beforehand by the other vehicle 200-1, 200-2.

For example, each vehicle 200-1, 200-2 of the plurality of vehicles sends its location, its speed and its trajectory to each other vehicle 200-1, 200-2 of the plurality of vehicles, and each vehicle 200-1, 200-2 of the plurality of vehicles then receives the location, the speed and the trajectory of each other vehicle 200-1 200-2 of the plurality of vehicles.

In the example illustrated in FIG. 2, the first vehicle 200-1 then receives the location, the speed and the trajectory of the second vehicle 200-2 and the second vehicle 200-2 receives the location, the speed and the trajectory of the first vehicle 200-1.

Each item of information sent by another vehicle 200-1, 200-2 is for example sent at regular time intervals, for example every second.

The first step 101 may comprise a second sub-step 1012 consisting, for at least one vehicle 200-1, 200-2 carrying out the first step 101, in using a sensor of the vehicle 200-1, 200-2 to determine at least one item of information contained in the set of information relating to another vehicle 200-1, 200-2 of the plurality of vehicles.

The sensor is for example a camera, a lidar (laser imaging detection and ranging) device or a radar (radio detection and ranging) device.

For example, a vehicle 200-1, 200-2 of the plurality of vehicles estimates the location and the speed of another vehicle 200-1, 200-2 of the plurality of vehicles located facing the vehicle 200-1, 200-2, a few meters or hundreds of meters away from the vehicle 200-1, 200-2.

In the example illustrated in FIG. 2, the first vehicle 200-1 then estimates the location and the speed of the second vehicle 200-2.

The first step 101 may comprise a third sub-step 1013 consisting, for at least one vehicle 200-1, 200-2 carrying out the first step 101, in estimating at least one item of information contained in the set of information relating to another vehicle 200-1, 200-2 of the plurality of vehicles, based on at least one item of information relating to traffic and/or signaling.

Each item of information relating to traffic and/or signaling is for example received directly from the city that is then connected to the vehicle 200-1, 200-2 of the plurality of vehicles carrying out the third sub-step 1013. Reference is then made to a smart city.

Each item of information relating to traffic and/or signaling sent by the city is for example sent at regular time intervals, for example every second, and over a circular perimeter with a predetermined diameter, for example a diameter equal to 500 meters.

Sending each item of information relating to traffic and/or signaling only within a circular perimeter makes it possible to avoid sending the information to vehicles that are not affected because they are located too far away.

Each item of information relating to traffic and/or signaling may be chosen from the following group of information relating to a zone: throughput of vehicles, location of stop signs, for example stop signs and/or give way signs, location of traffic lights, status of traffic lights, maximum permitted speed in the zone.

For example, each vehicle 200-1, 200-2 carrying out the first step 101 estimates the speed of each other vehicle 200-1, 200-2 of the plurality of vehicles as the maximum permitted speed in the zone in which the other vehicle 200-1 200-2 is located or a percentage of the maximum permitted speed in the zone, the value of the percentage depending on the throughput of vehicles in the zone.

As illustrated in FIG. 4, the first step 101 may comprise the first sub-step 1011 for a first subset of information of the set of information, the second sub-step 1012 for a second subset of information of the set of information and the third sub-step 1013 for a third subset of information of the set of information.

In the example illustrated in FIG. 2, the first vehicle 200-1 receives for example the trajectory and the location of the second vehicle 200-2 at a first instant, estimates the speed of the second vehicle 200-2 at a second instant later than the first instant by receiving information relating to traffic and/or signaling in a zone comprising the location received beforehand, and then, when the second vehicle 200-2 arrives nearby, determines the speed and the location at a third instant later than second instant, for example using a camera.

A second step 102 of the method 100 according to the invention consists, for at least one vehicle 200-1, 200-2 of the plurality of vehicles, in estimating a location of the crossing zone 202 and a time interval in which each vehicle 200-1, 200-2 is located in the crossing zone 202.

The second step 102 is for example carried out by each vehicle 200-1, 200-2 of the plurality of vehicles.

The estimation is carried out based on the set of information obtained in the first step 101, for example by estimating the location of each vehicle 200-1, 200-2 at each instant of a time interval later than the present instant.

In FIG. 2, the crossing zone 202 whose location was estimated in the second step 102 is shown in dashed lines.

Each vehicle 200-1, 200-2 of the plurality of vehicles carrying out the second step 102 has for example obtained the set of information in the first step 101 or received the set of information from another vehicle 200-1, 200-2 of the plurality of vehicles that carried out the first step 101.

The second step 102 is for example carried out each time a new item of information is added to the set of information.

The method 100 according to the invention may comprise a third step 103 consisting, for at least one vehicle 200-1, 200-2 of the plurality of vehicles, in receiving at least one item of information relating to public lighting in the crossing zone 202 at the location estimated and over the time interval estimated in the second step 102.

The third step 103 is for example carried out by each vehicle 200-1, 200-2 of the plurality of vehicles.

Each item of information relating to public lighting is for example received directly from the city that is then connected to the vehicle 200-1, 200-2 of the plurality of vehicles carrying out the third step 103.

Each item of information relating to public lighting may be chosen from the following group of information relating to a zone: location of each light beam emitted by public lighting, shape of each light beam emitted by public lighting, brightness of each light beam emitted by public lighting in the zone.

The third step 103 is for example carried out each time the second step 102 is carried out.

A fourth step 104 of the method 100 according to the invention consists, for at least one vehicle 200-1, 200-2 of the plurality of vehicles, at each instant of the time interval estimated in the second step 102, in estimating the illumination in the crossing zone 202 at the location estimated in the second step 102.

The fourth step 104 is for example carried out by each vehicle 200-1, 200-2 of the plurality of vehicles.

The estimation is carried out, for each vehicle 200-1, 200-2 of the plurality of vehicles, based on at least one characteristic of the light beam emitted by the vehicle 200-1, 200-2.

FIG. 2 shows, in the crossing zone 202, the illumination estimated in the fourth step 104 for a given instant of the time interval estimated in the second step 102.

The estimated illumination comprises an estimation of the first light beam 201-1 at the given instant shown in squares and an estimation of the second light beam 201-2 at the given instant shown in dotted lines.

If the third step 103 has been carried out, the estimation is also carried out based on each item of information relating to public lighting received in the third step 103.

The fourth step 104 is for example carried out each time the second step 102 or the third step 103 is carried out.

The following steps of the method 100 according to the invention are carried out only if, for at least one instant of the time interval estimated in the second step 102, there is at least one zone of overlap 2021 in the crossing zone 202 in which the illumination estimated for the given instant corresponds to the superposition of a plurality of light beams 201-1, 201-2 each emitted by a different vehicle 200-1, 200-2 of the plurality of vehicles.

In the example illustrated in FIGS. 2 and 3, there is therefore a zone of overlap 2021 if the illumination estimated for at least one instant of the time interval estimated in the second step 102 corresponds to the superposition of the first light beam 201-1 and the second light beam 201-2.

In FIG. 2, the zone of overlap 2021 between the estimation of the first light beam 201-1 and the estimation of the second light beam 201-2 at the given instant is shown in hatching.

A fifth step 105 of the method 100 according to the invention consists, for at least one vehicle 200-1, 200-2 of the plurality of vehicles, in obtaining a set of parameters comprising at least one parameter per vehicle 200-1, 200-2 of the plurality of vehicles, that is to say at least one parameter associated with the vehicle 200-1, 200-2.

Each parameter associated with a vehicle 200-1, 200-2 relates to the consumption of the associated vehicle 200-1, 200-2 or to the state of the lighting module of the associated vehicle 200-1, 200-2.

If the vehicle 200-1, 200-2 is an electric vehicle, each parameter associated with the vehicle 200-1, 200-2 relates for example to the electrical consumption of the vehicle 200-1 200-2, and if the vehicle 200-1, 200-2 is a combustion vehicle, each parameter associated with the vehicle 200-1, 200-2 relates for example to the fuel consumption of the vehicle 200-1, 200-2 or to the temperature of the lighting module.

The set of parameters comprises for example one parameter per vehicle 200-1, 200-2.

Each parameter associated with a vehicle 200-1, 200-2 of the plurality of vehicles depends on at least one datum sent by the vehicle 200-1, 200-2 associated with the parameter, to the vehicle 200-1, 200-2 carrying out the fifth step 105.

If the vehicle 200-1, 200-2 of the plurality of vehicles is an electric vehicle, each datum sent by the vehicle 200-1, 200-2 is for example chosen from the following group of data: range of the vehicle 200-1, 200-2, remaining distance to be traveled by the vehicle 200-1, 200-2, ratio between range of the vehicle 200-1 200-2 and remaining distance to be traveled by the vehicle 200-1, 200-2, model of the vehicle 200-1, 200-2, brightness of the light beam 201-1, 201-2 emitted by the vehicle 200-1, 200-2, brightness of the light beam 201-1, 201-2 emitted by the vehicle 200-1, 200-2 with respect to a regulatory minimum brightness.

If the vehicle 200-1, 200-2 of the plurality of vehicles is a combustion vehicle, each datum sent by the vehicle 200-1, 200-2 is for example chosen from the following group of data:
fuel consumption of the vehicle 200-1, 200-2, remaining distance to be traveled by the vehicle 200-1, 200-2, ratio between fuel consumption of the vehicle 200-1, 200-2 and remaining distance to be traveled by the vehicle 200-1, 200-2, model of the vehicle 200-1, 200-2, consumption of the lighting module of the vehicle 200-1, 200-2, ratio between consumption of the lighting module of the vehicle 200-1, 200-2 and remaining distance to be traveled by the vehicle 200-1, 200-2, brightness of the light beam 201-1, 201-2 emitted by the vehicle 200-1, 200-2, brightness of the light beam 201-1, 201-2 emitted by the vehicle 200-1, 200-2 with respect to the regulatory minimum brightness, temperature of the lighting module of the vehicle 200-1, 200-2.

If the vehicle 200-1, 200-2 of the plurality of vehicles is a hybrid vehicle, each datum sent by the vehicle 200-1, 200-2 is for example chosen from the group of data described above for an electric vehicle and/or from the group of data described above for a combustion vehicle.

Each parameter associated with a vehicle 200-1, 200-2 of the plurality of vehicles may be equal to a datum sent by the vehicle 200-1, 200-2 or computed based on at least one datum sent by the vehicle 200-1, 200-2.

If the vehicle 200-1, 200-2 of the plurality of vehicles is an electric vehicle, each parameter associated with the vehicle 200-1, 200-2 is for example chosen from the following group of parameters: range of the vehicle 200-1, 200-2, ratio between range of the vehicle 200-1, 200-2 and remaining distance to be traveled by the vehicle 200-1, 200-2, model of the vehicle 200-1, 200-2. If the vehicle 200-1, 200-2 of the plurality of vehicles is a combustion vehicle, each parameter associated with the vehicle 200-1, 200-2 is for example chosen from the following group of parameters: fuel consumption of the vehicle 200-1, 200-2, ratio between fuel consumption of the vehicle 200-1, 200-2 and remaining distance to be traveled by the vehicle 200-1, 200-2, model of the vehicle 200-1, 200-2, consumption of the lighting module of the vehicle 200-1, 200-2, ratio between consumption of the lighting module of the vehicle 200-1, 200-2 and remaining distance to be traveled by the vehicle 200-1, 200-2, temperature of the lighting module of the vehicle 200-1, 200-2. If the vehicle 200-1, 200-2 of the plurality of vehicles is a hybrid vehicle, each parameter associated with the vehicle 200-1, 200-2 is for example chosen from the group of parameters described above for an electric vehicle and/or from the group of parameters described above for a combustion vehicle.

A sixth step 106 of the method 100 according to the invention consists in determining at least one action to be carried out by a vehicle 200-1, 200-2 of the plurality of vehicles so that the illumination in the zone of overlap 2021 is distributed among the plurality of vehicles 200-1, 200-2 in such a way as to exhibit a predefined brightness.

The determination is carried out based on the set of parameters obtained in the sixth step 106 and collectively between the plurality of vehicles.

Each action to be carried out by a vehicle 200-1, 200-2 of the plurality of vehicles relates to the light beam 201-1, 201-2 emitted by the vehicle 200-1, 200-2.

Each action to be carried out by a vehicle 200-1, 200-2 of the plurality of vehicles is for example chosen from the following group of actions: turning off the light beam 201-1, 201-2 in the zone of overlap 202, or reducing the brightness of the light beam 201-1, 201-2 by a predetermined value in the zone of overlap 202.

The lighting module of each vehicle 200-1, 200-2 of the plurality of vehicles comprises for example a solid-state light source having a plurality of elementary emitters the current of which is controlled individually by way of pulse width modulation, that is to say the luminous intensity of each elementary emitter corresponds to the average current flowing through it, which depends on an applied peak current value and an applied duty cycle.

The brightness of the light beam 201-1, 201-2 emitted by the lighting module may then be reduced, for example by reducing the peak current value or the duty cycle applied to at least one elementary emitter of the lighting module.

The predefined brightness is for example defined on the basis of the regulatory minimum brightness and/or the brightness of at least one light beam 201-1, 201-2 superimposed in the zone of overlap 2021.

If only a first light beam 201-1 and a second light beam 201-2 are superimposed in the zone of overlap 2021, the predefined brightness is for example the average of the brightness of the first light beam 201-1 and the brightness of the second light beam 201-2.

The sixth step 106 may comprise a first sub-step 1061 consisting, for the vehicle 200-1, 200-2 of the plurality of vehicles that carried out the fifth step 105, in comparing the set of parameters obtained in the fifth step 105 in order to determine at least one optimum parameter.

The first sub-step 1061 is carried out only if each vehicle 200-1, 200-2 of the plurality of vehicles is associated with one and the same parameter type of the set of parameters.

For example, each vehicle 200-1, 200-2 of the plurality of vehicles is an electric vehicle and is associated, in the set of parameters, with a parameter of the type ratio between range of the vehicle 200-1, 200-2 and remaining distance to be traveled by the vehicle 200-1, 200-2.

The optimum parameter may be the minimum parameter or the maximum parameter of the set of parameters depending on the parameter type.

The optimum parameter is for example the maximum parameter if the parameter is of the type ratio between range of the vehicle 200-1, 200-2 and remaining distance to be traveled by the vehicle 200-1, 200-2, and the minimum parameter if the parameter is of the type ratio between fuel consumption of the vehicle 200-1, 200-2 and remaining distance to be traveled by the vehicle 200-1, 200-2.

The sixth step 106 may comprise a second sub-step 1062 consisting, for each vehicle 200-1, 200-2 of the plurality of vehicles, in communicating with the other vehicles 200-1, 200-2 of the plurality of vehicles in order to make a common decision on each action to be carried out.

The second sub-step 1062 is carried out for as long as the plurality of vehicles are not located in the crossing zone 202 and each action to be carried out has not been determined.

The decision is made in such a way as to maximize the amount of illumination in the zone of overlap 202 provided by each vehicle 200-1, 200-2 associated with an optimum parameter determined in the first sub-step 1061 in the set of parameters.

For example, if the ratio between the optimum parameter associated with a vehicle 200-1, 200-2 and the parameter associated with each other vehicle 200-1, 200-2 of the plurality of vehicles is greater than a first threshold, the plurality of vehicles communicate so that the action to be determined consists for example, for each other vehicle 200-1, 200-2, in turning off its light beam 201-1, 201-2, if the ratio is between a second threshold and a first threshold, the plurality of vehicles communicate so that the action to be carried out consists for example, for each other vehicle 200-1, 200-2, in reducing the brightness of its light beam 201-1, 201-2 so that the amount of illumination of the vehicle 200-1, 200-2 is greater than the amount of illumination of all of the other vehicles 200-1, 200-2, for example 70% for the vehicle 200-1, 200-2 and 30% for all of the other vehicles 200-1, 200-2, and if the ratio is less than the second threshold, the plurality of vehicles communicate so that the action to be determined consists for example in distributing the illumination evenly between each vehicle 200-1, 200-2 of the plurality of vehicles.

In FIG. 3, the zone of overlap 2021 is illuminated only by the first light beam 201-1, and the first vehicle 200-1 and the second vehicle 200-2 have therefore agreed that the action to be carried out consists, for the second vehicle 200-2, in turning off its light beam 201-2 in the zone of overlap 2021. If each action to be carried out has not been determined, that is to say no common decision has been able to be made, before the plurality of vehicles are located in the crossing zone 202, the action to be carried out is for example a first default action to be carried out by each vehicle 200-1, 200-2 of the plurality of vehicles.

The first default action consists for example, for each vehicle 200-1 200-2 of the plurality of vehicles, in providing an equal amount of illumination in the zone of overlap 202, that is to say a brightness equal to the predefined brightness divided by the number of vehicles 200-1, 200-2 in the plurality of vehicles.

If each vehicle 200-1, 200-2 of the plurality of vehicles is not associated with one and the same parameter type in the set of parameters, the first sub-step 1061 cannot be carried out and the action to be carried out is then for example a second default action to be carried out by each vehicle 200-1, 200-2 of the plurality of vehicles.

The second default action is for example identical to the first default action.

For example, at least one vehicle 200-1, 200-2 of the plurality of vehicles is an electric vehicle and is associated, in the set of parameters, with a parameter of the type ratio between range of the vehicle 200-1, 200-2 and remaining distance to be traveled by the vehicle 200-1, 200-2, and at least one vehicle 200-1, 200-2 of the plurality of vehicles is a combustion vehicle and is associated, in the set of parameters, with a parameter of the type ratio between fuel consumption of the vehicle 200-1, 200-2 and remaining distance to be traveled by the vehicle 200-1, 200-2.

A seventh step 107 of the method 100 consists in the corresponding vehicle 200-1, 200-2 of the plurality of vehicles carrying out each action determined in the sixth step 106 when the plurality of vehicles is located in the crossing zone 202.

In FIG. 3, the zone of overlap 2021 is illuminated only by the first light beam 201-1, and the second vehicle 200-2 has therefore carried out the action consisting in turning off its light beam 201-2 in the zone of overlap 2021.

The method 100 according to the invention may comprise an eighth step 108 that is carried out if a first condition CI, whereby communication between the plurality of vehicles is interrupted, is satisfied, before each action to be carried out has been determined.

The eighth step 108 consists, for each vehicle 200-1, 200-2 of the plurality of vehicles, in carrying out a third default action when the plurality of vehicles are located in the crossing zone 202.

The third default action is for example identical to the first default action.

What is claimed is:

1. A method for optimizing illumination in a crossing zone between a plurality of vehicles each vehicle including a lighting module emitting an associated light beam, the method comprising:
at least one vehicle estimating a location of the crossing zone and a time interval in which each vehicle is located in the crossing zone, based on a set of information including at least a location, a speed and a trajectory of each vehicle;
at least one vehicle estimating the illumination in the crossing zone at the estimated location and at each instant of the estimated time interval, based, for each vehicle, on at least one characteristic of the associated light beam,
determining if, for at least one instant of the estimated time interval, there is at least one zone of overlap in the crossing zone in which the estimated illumination corresponds to the superposition of a plurality of associated light beams:
at least one vehicle obtaining a set of parameters including at least one parameter per vehicle each parameter depending on at least one datum sent beforehand to the vehicle by the vehicle associated with the parameter and relating to the consumption or the state of the lighting module of the vehicle associated with the parameter;
determining, by communication between the plurality of vehicles and based on the obtained set of parameters, at least one action to be carried out by a vehicle on the associated light beam so that the illumination in the zone of overlap is distributed among the plurality of vehicles in such a way as to exhibit a predefined brightness; and
the corresponding vehicle carrying out each determined action when the plurality of vehicles are located in the crossing zone.

2. The method as claimed in claim 1, further comprising at least one vehicle obtaining the set of information, including, for at least one item of information of the set of information relating to another vehicle of the plurality of vehicles, including receiving the information sent beforehand by the other vehicle, or determining the information using a sensor of the vehicle, or estimating the information based on at least one item of information relating to traffic and/or signaling.

3. The method as claimed in claim 1, further comprising at least one vehicle receiving at least one item of information relating to public lighting in the crossing zone-(202) at the estimated location and at each instant of the estimated time interval, the step of estimating the illumination in the crossing zone also being carried out based on each received item of information relating to public lighting.

4. The method as claimed in claim 1 wherein the at least one vehicle estimating the illumination in the crossing zone includes, for each characteristic of the light beam associated with another vehicle, receiving the characteristic sent beforehand by the other vehicle.

5. The method as claimed in claim 1, wherein each characteristic is chosen from the following group of characteristics: type, shape, brightness, brightness with respect to a regulatory minimum brightness.

6. The method as claimed in claim 1, wherein each datum is chosen from the following group of data: range, remaining distance to be travelled, ratio between range and remaining distance to be travelled, fuel consumption, ratio between fuel consumption and remaining distance to be travelled, model, consumption of the lighting module, ratio between consumption of the lighting module and remaining distance to be travelled, brightness of the emitted light beam, brightness of the emitted light beam with respect to a regulatory minimum brightness, temperature of the lighting module.

7. The method as claimed in claim 1, wherein each parameter is chosen from the following group of parameters:
range, ratio between range and remaining distance to be travelled, fuel consumption, ratio between fuel consumption and remaining distance to be travelled, model, consumption of the lighting module, ratio between consumption of the lighting module and remaining distance to be travelled, temperature of the lighting module.

8. The method as claimed in claim 1, wherein each action to be carried out is that of turning off or reducing the brightness of the associated light beam by a predetermined value.

9. The method as claimed in claim 1, wherein each parameter of the set of parameters has a type, and the determining each action to be carried out by:
If each vehicle is associated with one and the same parameter type of the set of parameters:
Carrying out a comparison between the set of parameters in order to determine at least one optimum parameter;
For as long as the plurality of vehicles are not located in the crossing zone and each action to be carried out has not been determined, the plurality of vehicles communicating with one another in order to decide on each action to be carried out in such a way as to maximize the amount of illumination in the zone of overlap provided by each vehicle associated with an optimum parameter of the set of parameters;
Otherwise, the determined action is a first default action to be carried out by each vehicle on the associated light beam;
Otherwise, the determined action is a second default action to be carried out by each vehicle on the associated light beam.

10. The method as claimed in claim 1, further comprising each vehicle carrying out a third default action on the associated light beam when the plurality of vehicles are located in the crossing zone, and communication is interrupted between the plurality of vehicles before each action to be carried out has been determined.

11. A vehicle comprising:
a lighting module configured to emit a light beam;
a computer configured to:
estimate a location of the crossing zone and a time interval in which each vehicle is located in the crossing zone, based on a set of information comprising at least a location, a speed and a trajectory of each vehicle,
estimate the illumination in the crossing zone at the estimated location and at each instant of the estimated time interval, based, for each vehicle, on at least one characteristic of the associated light beam;
detect each zone of overlap in the crossing zone in which the estimated illumination corresponds to the superposition of a plurality of light beams;
if a zone of overlap is detected:
obtain a set of parameters comprising at least one parameter per vehicle, each parameter depending on at least one datum sent beforehand by the vehicle associated with the parameter;
determine, by communicating with the other vehicles of the plurality of vehicles and based on the obtained set of parameters, at least one action to be carried out by a vehicle on the associated light beam so that the illumination in the zone of overlap is distributed among the plurality of vehicles in such a way as to exhibit a predefined brightness;
if a determined action is to be carried out, carry out the determined action on the light beam emitted by the lighting module when the plurality of vehicles are located in the crossing zone.

12. (canceled)

13. A computer-readable recording medium including instructions which, when executed by a computer, cause the computer to:
at least one vehicle estimate a location of the crossing zone and a time interval in which each vehicle is located in the crossing zone, based on a set of information including at least a location, a speed and a trajectory of each vehicle;
at least one vehicle estimate the illumination in the crossing zone at the estimated location and at each instant of the estimated time interval, based, for each vehicle, on at least one characteristic of the associated light beam,
determine if, for at least one instant of the estimated time interval, there is at least one zone of overlap in the crossing zone in which the estimated illumination corresponds to the superposition of a plurality of associated light beams:
at least one vehicle obtain a set of parameters including at least one parameter per vehicle, each parameter depending on at least one datum sent beforehand to the vehicle by the vehicle associated with the parameter and relating to the consumption or the state of the lighting module of the vehicle associated with the parameter;
determine, by communication between the plurality of vehicles and based on the obtained set of parameters, at least one action to be carried out by a vehicle on the associated light beam so that the illumination in the zone of overlap is distributed among the plurality of vehicles in such a way as to exhibit a predefined brightness; and
the corresponding vehicle carry out each determined action when the plurality of vehicles are located in the crossing zone.
